(19) United States
(12) Patent Application Publication
(10) Pub. No.: US 2004/0216903 A1
(43) Pub. Date: Nov. 4, 2004

(54) Hermetically sealed gas propellant cartridge for fire extinguishers

(76) Inventors: Paul H. Wierenga, Seattle, WA (US); Cristy A. Kumasaka, Bothell, WA (US); David C. Hobson, Edgewood, WA (US); Alexander J. Mathers, Camano Island, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/756,837

(22) Filed: Jan. 13, 2004

Related U.S. Application Data
(60) Provisional application No. 60/463,485, filed on Apr. 15, 2003.

(51) Int. Cl. A62C 35/58

(52) U.S. Cl. 169/85

(57) ABSTRACT

A fire extinguisher includes a tank and a gas generator breech connected to the tank. The gas generator breech is provided with a hermetically sealed gas generator cartridge. The hermetically sealed gas generator cartridge avoids the need to have a release poppet or burst shims on the gas generator breech. The enclosed space that contains combustion gas pressure is provided by the gas generator cartridge itself and not the gas generator breech. The gas generator cartridge is made from a container that can be the precursor to a beverage can used for carbonated beverages. The beverage can may come in a thickness and material of construction that makes it a suitable, cost-effective container for the gas generator cartridge. However, other containers besides precursors of beverage cans can be used.

### FIELD OF THE INVENTION

This invention relates to fire suppression systems, and more specifically to fire extinguishers with solid propellant, gas generators.

### BACKGROUND OF THE INVENTION

There is an increasing need for improved mobility and rapid-deployment capability in fire extinguishing technology. This need is driving the development of highly effective, compact, lightweight, non-toxic and environmentally friendly fire suppression systems. Today, a wide variety of fire-extinguishing technologies and fire extinguisher constructions exist, including extinguishers charged with compressed and/or liquefied gas and solid propellant-actuated extinguishers.

A recent advance in fire suppressant technology has been the use of solid propellant, gas generating fire extinguishers based upon technology similar to that used in automobile airbag devices. In this approach to fire extinguishers, a gas generator in the form of solid propellants is ignited to generate large quantities of nitrogen, carbon dioxide, and water vapor. In the context of automobile airbags, these combustion gases inflate the airbag. In the context of fire extinguishers, these gases can act as the fire suppressant. See, for example, U.S. Pat. Nos. 6,217,788 and 6,024,889, incorporated herein by reference in their entirety. This type of fire extinguisher is known as a solid propellant fire extinguisher (SPFE).

Alternatively, when the solid propellant is ignited within an enclosed space, a rapid increase in pressure is produced that can be used to propel a secondary gas or fluid fire suppressant from a tank. The enclosed space must have means to release the built-up pressure into the tank and to separate the fire suppressant from the solid propellant gas generator. Conventional fire extinguishers use a type of shield, such as a spring-biased release poppet, or burst disk, to close off the solid propellant from the fluid fire suppressant in the tank, and to open under the pressure of the propellant gases. See, for example, U.S. Pat. Nos. 5,423,384; 5,449,041; and 5,613,52 and International Application Nos. PCT/US/06622 and PCT/US/05953. All patents and applications are incorporated herein by reference in their entirety. Upon combustion of the solid propellant, the gases burst through the shield, pressurizing the tank. This pressurization of the tank drives the fluid fire suppressant through a second burst disk or release poppet and out of a nozzle. Fire extinguishers that combine the use of a solid propellant gas generator with a fluid fire suppressant are called hybrid fire extinguishers (HFEs).

A hybrid fire extinguisher, as disclosed in International Application No. PCT/JUS00/05953, uses a gas generator breech assembly to provide an enclosed space that is closed off from the fluid fire suppressant. A gas generator cartridge is inserted into the gas generator breech assembly. The gas generator breech assembly has a spring-biased release poppet that is normally closed, and opens at a set pressure to allow the escape of gases produced by the cartridge. The interior of the gas generator breech and gas generator cartridge is thus kept closed off from the fluid fire suppressant. This design is disadvantageous because the release poppet introduces complexity into the system in the form of moving parts. In addition, the propellant cartridge needs to be shipped under a less desirable shipping classification since it is not hermetically sealed. Some hybrid extinguishers may have a gas generator breech with holes that are sealed by brazing, welding, or adhesively bonding burst shims to the holes to keep the gas generator cartridge closed off from the fluid fire suppressant. This design is disadvantageous because the refurbishment process to reinstall the shims after the fire extinguisher has been discharged, is both time and cost prohibitive.

Thus, there is a need for highly effective, compact, lightweight, non-toxic and environmentally friendly fire extinguishers that are useful in vehicles and other enclosed spaces which can be easily shipped and subsequently refurbished in the field after use.

### SUMMARY OF THE INVENTION

A fire extinguisher according to the present invention includes a tank and a gas generator breech connected to the tank. The gas generator breech is provided with a hermetically sealed gas generator cartridge. The hermetically sealed gas generator cartridge is hermetically sealed before being placed in the gas generator breech of a fire extinguisher. The gas generator cartridge is hermetically sealed apart, and away from the fire extinguisher, thus providing a more desirable shipping classification for the cartridge. The hermetically sealed gas generator cartridge avoids the need to have a release poppet or burst shims on the gas generator breech. The enclosed space that contains combustion gas pressure is provided by the gas generator cartridge itself and not the gas generator breech. The gas generator cartridge is made from a container that can be the precursor container used for a beverage or food can. Precursor beverage and food cans are intended to include any container not specifically made to be used as a gas generating cartridge container. One such suitable container is a precursor of a soda pop can. The precursor container of a beverage or food can already comes in a thickness and material of construction that makes it a suitable, cost-effective container for use in the gas generator cartridge of the invention. However, other containers that are not precursors of beverage or food cans can be used to make the gas generator cartridge. The gas generator cartridge further includes a lid that hermetically seals the propellant within the container. The lid may have an area of localized weakness, such as decreased thickness or scoring, where the firing squib and initiator will be situated adjacent thereto. Alternatively, the lid may be of a substantially constant thickness and not have a localized weakness in the area of the initiator.

The fire extinguisher further includes a burst disk at an outlet of the tank to keep the fire suppressant within the tank, and opens or ruptures to allow the fire suppressant to discharge from the tank when the tank is pressurized. The gas generator breech according to the present invention does not have burst shims or release poppets to enclose the solid propellant because the solid propellant is enclosed within a hermetically sealed cartridge. The gas generator breech interior is therefore open to the tank interior. The gas generator cartridge container serves as the burst disk formerly used on the breech. The cartridge container can rupture to release the combustion gases through unsealed openings in the gas generator breech. The gas generator cartridge exterior is therefore open and exposed to the tank interior and can be in contact with the fire suppressant fluid. The container used for the gas generator cartridge is designed to have a burst pressure in the range of about 500 psig to about 4000 psig.

Another embodiment of the present invention is related to a gas generator cartridge that comprises a hermetically sealed container containing a solid, gas generating propellant known by the designations FS01-40 or PAC 3304. Representative compounds suitable as propellants are described in U.S. Pat. Nos. 6,024,889; 5,613,562; 5,449,041; 5,423,384; and 6,217,788 and International Application Nos. PCT/US94/06622 and PCT/US00/05952. The gas generator cartridge can further include a booster propellant that is initially ignited by the firing squib. A designation of one such propellant is FS01-00. Examples of other propellants are described in U.S. Pat. Nos. 6,024,889; 5,613,562; 5,449,041; 5,423,384; and 6,217,788 and International Application Nos. PCT/US94/06622 and PCT/IUS00/05952. A screen or perforated cup can divide the solid propellant from the booster propellant within the container. The gas generator cartridge includes foam pads that are placed between the cartridge container ends and the solid propellant or the booster propellant. The foam pads prevent the propellant from breaking apart or crumbling caused by hitting against the interior surfaces of the container during vibration and shock environments. The gas generator cartridge includes a perforated tube that is interior to the container. The solid propellant and the booster propellant are located interior to the tube. The tube is perforated to allow the combustion gases to pass through the tube perforations and pressurize the interior of the cartridge. The container for the cartridge has an average sidewall thickness of about 2/1000 inch to about 10/1000 inch.

The solid propellant of the gas generator cartridge is kept out of contact with the tank interior and fire suppressant without the need to have a release poppet valve, or burst shims on the gas generator breech. In the present invention, the solid propellant, however, is contained within a hermetically sealed gas generator cartridge. The cartridge is comprised of a container that is set to rupture, avoiding the need to provide release poppets or burst shims on the breech.

Thus, refurbishment of the fire extinguisher involves replacing the spent cartridge with a new cartridge, whereas before, the gas generator breech interior had to be smoothed down of burst shim remnants, and new burst shims brazed to the gas generator breech holes. The present invention thus avoids the need to have moving parts, the need to smooth down the gas generator breech interior, and the need to rebraze burst shims to cover the gas generator breech holes after every functioning of the fire extinguisher.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a cross-sectional illustration of a fire extinguisher with an open gas generator breech and a hermetically sealed, solid propellant, gas generator cartridge in the breech of the fire extinguisher according to the present invention;

FIG. 2 is an enlarged fragmentary illustration of the fire extinguisher of FIG. 1 showing the upper portion of the fire extinguisher illustrated in FIG. 1;

FIG. 3 is a cross-sectional illustration of a hermetically sealed, solid propellant, gas generator cartridge according to the present invention; and

FIG. 4 is a cross-sectional illustration of a fire extinguisher with an alternate configuration for an open, unsealed gas generator breech.

### DETAILED DESCRIPTION OF THE PREFERRED EMBODIMENT

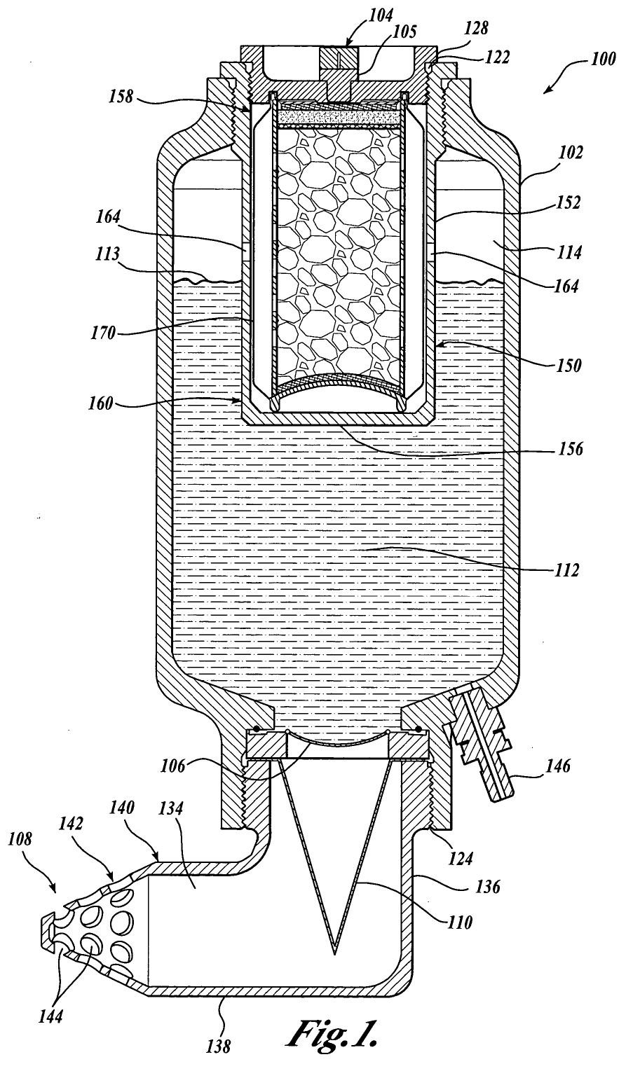

FIG. 1 is an illustration of a fire extinguisher 100 according to the present invention. The fire extinguisher 100 includes a tank 102 and a gas generator breech 150 within the tank 102. A gas generator breech 150 is the portion of the fire extinguisher 100 configured to house a gas generator cartridge 170. Conventionally, gas generator breeches have their interiors fully closed off from the interior of the tank. The gas generator cartridge typically contains solid propellants that when ignited, produce combustion gases to pressurize the tank and expel a secondary or fluid fire suppressant. Previously, because gas generator cartridges were not hermetically sealed, the gas generator breech interior had to be closed off from the tank interior with burst shims or release poppets as described in the background section above.

According to the present invention, a hermetically sealed, gas generator cartridge 170 is provided in the gas generator breech 150 of the fire extinguisher 100. Therefore, the gas generator breech 150 of the present invention does not require burst shims, release poppets, or other gas generator breech closures to maintain separation between the solid propellant and the tank interior 114. The gas generator breech of the present invention is open or unsealed due to the advantage of having a hermetically sealed gas generator cartridge. For operation as a fire extinguisher 100, the tank 102 contains a fluid fire suppressant 112 that is fully or partially volatizable on contact with the hot combustion gases produced from the gas generator cartridge 170. Suitable fire suppressants are disclosed in the International Application No. PCT/US00/05953 as well as in the other applications and patents mentioned in the background section above. Representative fire suppressants include perfluorocarbons (PFCs) and hydrofluorocarbons (HFCs). A preferred fire suppressant is known under the designation HFC-227ea (CF₃CHFCF₃) (1,1,1,2,3,3,3-Heptafluoropropane), or any equivalent thereof. Water-based fire suppressants may also be used in hybrid fire extinguishers pending design, performance, and environmental evaluations. A preferred water-based fire suppressant includes water, potassium acetate (as a freezing point depressant), and a surfactant.

Referring still to FIG. 1, the tank 102 that holds the fire suppressant 112 can be cylindrical in shape, defining a first end and a second end. For purposes of describing the fire extinguisher 100 of FIG. 1, the first and second ends will be described as the upper end and the lower end, respectively. However, directional language used herein, should not be construed to limit the present invention to any one particular orientation. The tank can be fabricated from any suitable materials that are compatible with the selected fire suppressant and intended environment in which the fire extinguisher is to be used. Representative materials include but are not limited to 17-4 Ph, 17-7 Ph, 15-5 Ph, 13-8 Ph, 300 series stainless steel. Other suitable construction materials for the tank and for other components of the fire extinguisher are generally described in the above-mentioned patents and applications mentioned in the background section.

The tank 102 has neck openings 122 and 124 at the upper end and the lower end of the tank, respectively. Each of the neck openings 122 and 124 has an inner diameter that may be smaller compared to the inner diameter of the tank 102. The upper neck opening 122 of the tank has the gas generator breech 150 attached thereto. The lower neck opening 124 has a nozzle 108 attached thereto.

The gas generator breech 150 comprises a cylindrical sleeve 152 which serves to hold the hermetically sealed, gas generator cartridge 170. The sleeve 152 is substantially radially symmetrical about its central longitudinal axis. An end plate 156 is attached to the lower end 160 of the cylindrical sleeve 152 to support the gas generator cartridge 170. The sleeve 152 is open at the upper end 158, but is configured to accept a cover 128. The sleeve 152 and/or end plate 156 may be provided with one or more holes 164 that function to pass the combustion gases generated from the gas generator cartridge 170 into the interior of the tank 114. The gas generator breech sleeve 152 and end plate 156 can be manufactured from materials similar to the tank materials described above. Representative materials for the gas generator breech sleeve and end plate are 13-8 Ph, 15-5 Ph, carpenter 455.

The size and number of holes 164 located on the cylindrical sleeve 152 and/or on the end plate 156 can be based on the intended discharge rate of combustion gases and burst pressure desired from the gas generator cartridge 170. The size and number of holes 164 can be readily calculated to provide sufficient flow of combustion gases from the interior of the gas generator breech 150 to the interior of the tank 114.

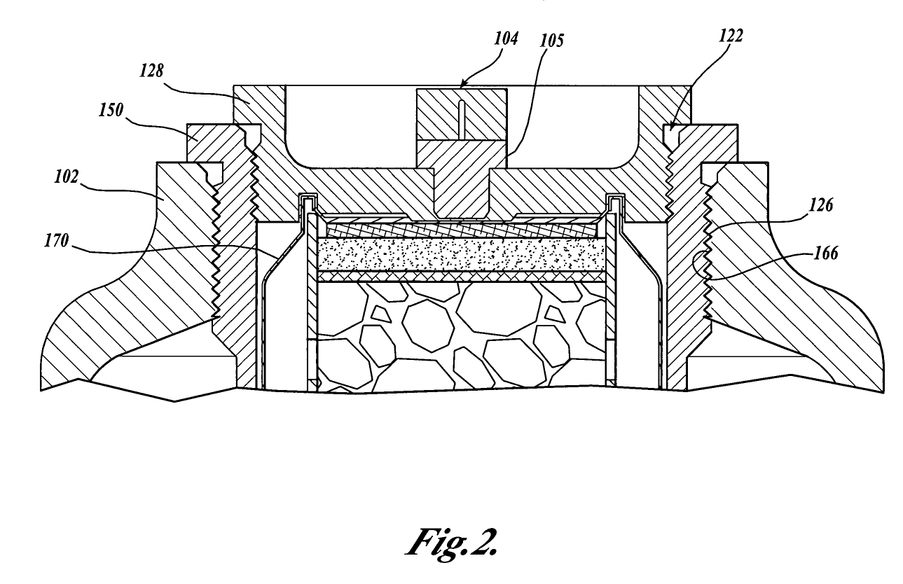

Referring now to FIG. 2, the upper portion of the breech 150 can have threads 166 around the external circumference of the breech 150. The upper neck opening 122 has internal threads 126 that engage with the external threads on the breech 150. If desired, the gas generator breech 150 can be connected with the tank upper neck opening 122 with more “permanent” bonding methods, such as brazing, soldering, or welding. Threaded connections more readily provide the option to replace damaged or worn components.

Referring again to FIG. 1, a cover 128 is provided at the upper open end 158 of the gas generator breech 150. The cover 128 functions to prevent combustion gases from exiting the gas generator breech 150 through the upper end of the gas generator breech. The cover 128 can likewise be connected to the breech 150 with a threaded, or other non-permanent connection. The cover 128 is also configured to hold an initiator assembly 104 with squib 105 that ignites the solid propellant contained within the gas generator cartridge 170. To this end, the gas generator cartridge 170 has a lid that may be scored or otherwise has an area of decreased thickness in proximity to the squib 105 to enable the burning and/or rupture of the lid and ignition of the solid propellant 184 within the gas generator cartridge 170.

A nozzle 108 is connected to the lower neck opening 124 of the tank 102. In one embodiment, the nozzle 108 comprises an elbow-shaped member 136. The vertical leg of the elbow 136 is connected to the inner circumference of the lower neck opening 124. The horizontal leg of the elbow 136 terminates in a discharge head 140 that includes a plurality of holes 144 to distribute the fire suppressant 112 over a widely dispersed area. The discharge head 140 comprises a conical-shaped member 142 attached to the elbow 136. The holes 144 are located circumferentially about the cone 142 at various heights from the base of the cone. In another embodiment, the nozzle connects the tank to a fire suppressant distribution system.

A tank burst disk 106 is provided at the transition between the tank interior 114 and the nozzle interior 134. The nozzle 108 can be connected to the tank 102 by threads, and/or some other removable mechanism such that the burst disk 106 can be replaced. The tank burst disk 106 is preferably configured to burst at a pressure in the range of about 500 psig to about 1500 psig. Alternatively, in lieu of a tank burst disk, the fire extinguisher can be provided with pressure relief valves, such as spring actuated release poppets. If a tank burst disk 106 is used, a filter 110 can be provided in the nozzle interior 134 downstream of the tank burst disk 106 to prevent any metal fragments from being expelled through the discharge head 140 along with the fire suppressant 112. Flying metal fragments pose a danger to people and equipment. The filter 110 is able to trap small particulates of metal, while inducing only minimal pressure drop.

The tank 102 includes a dual-purpose vent and fill valve 146. The vent and fill valve 146 has a suitable coupling to enable recharging the tank 102 with the fire suppressant 112. The vent and fill valve 146 is located on the tank 102 to reload the tank 102 with fire suppressant 112 or to vent excess fire suppressant 112 from the tank 102. A suitable vent and fill valve 146 is described in SAE Standard AS 28889.

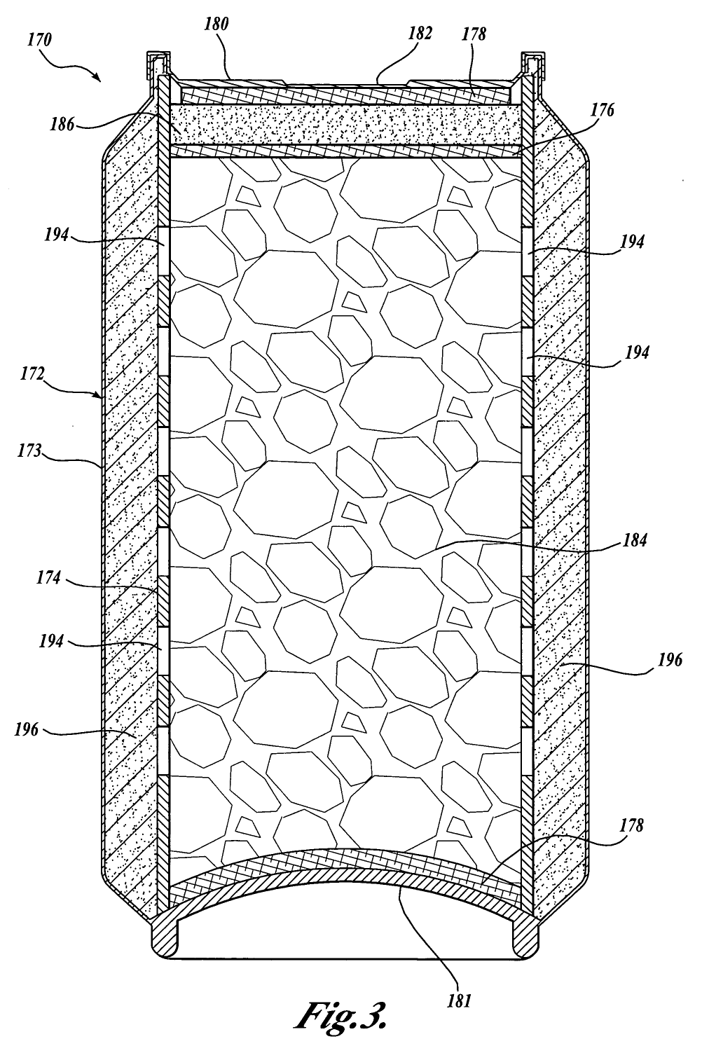

Referring now to FIG. 3, a hermetically sealed, solid propellant, gas generator cartridge 170 according to the present invention, is illustrated.

The gas generator cartridge 170 comprises a container 172 that serves as the exterior shell of the gas generator cartridge 170 and contains the solid, gas generating propellant 184 and other cartridge components. The container 172 may be constructed from one of a number of materials including metals and plastics, with a wall thickness determined by the desired burst pressure and type of the material. The burst pressure of the gas generator cartridge may be about 500 psig to about 4000 psig. The container walls 173 and/or bottom 181 can have an average thickness of about 2/1000 inch to about 10/1000 inch.

In one embodiment of the gas generator cartridge, the container 172 can be the steel and/or aluminum container that is the precursor to beverage cans used for carbonated beverages, such as a soda pop can. Containers fabricated for use in food and beverage applications may make suitable containers for the gas generator cartridge because some of these containers can come in suitable wall thicknesses to serve as the container for the hermetically sealed, gas generator cartridge according to the present invention. A precursor beverage or food can for use as the container of the gas generator cartridge need not be provided with a top lid and the precursor of the beverage or food can does not need to be coated with food grade linings. The precursors to beverage or food cans already come fabricated in suitable materials, such as aluminum and steel, compatible with the propellant and the precursor beverage or food cans are of suitable wall thickness that produces the appropriate amount of burst pressure. The precursor beverage or food can will be provided with a lid to hermetically seal the propellant within the precursor beverage or food can. As applied to the container and gas generator cartridge of the present invention, “hermetic seal” or “hermetically sealed” or any derivation thereof, means gastight, including highly resistant and/or impermeable to air penetration, fire suppressant vapor, or other gases. In one embodiment, the lid 180 used to seal the precursor of the beverage or food can, or other suitable container, is provided with a localized weakness area 182 in the location where a squib can burn through and/or rupture the lid 180 and ignite the propellant 184 contained within the container 172, thus initiating the chain of events that result in the fire suppressant 112 being discharged from the fire extinguisher nozzle 108. Another embodiment of a fire extinguisher includes having a powerful initiator that eliminates the need to provide a localized weakness area on the lid 180.

Referring to FIGS. 1 and 3, when the gas generator cartridge is in the fire extinguisher breech, the exterior of the container walls 173 are buttressed against the interior walls of the gas generator breech sleeve 152 and the container bottom 181 is supported by the gas generator breech end plate 156. However, the exterior of the gas generator cartridge container walls 173 and/or container bottom 181 are not buttressed in the locations where the gas generator breech sleeve 152 and/or end plate 156 is provided with holes 164. Upon ignition of the propellant 184, the pressure is distributed equally to all inner surfaces of the gas generator cartridge container 172. The pressure inside the gas generator cartridge 170 will exceed the strength of the container and rupture in the locations that are not buttressed by the inner walls of the gas generator breech sleeve 152, end plate 156, or cover 128. The burst pressure of the gas generator cartridge 170 is about 500 psig to about 4000 psig. The heat and pressure generated by the combustion of the propellant 184 within the gas generator cartridge 170 produces gases sufficient to pressurize the interior of the tank 102. This pressure is relieved by rupturing of the tank burst disk 106 and expelling the combustion gases along with the fire suppressant 112 through the nozzle 108.

The gas generator cartridge 170 contains a solid gas generating propellant 184. Upon combustion, the propellant 184 within the gas generator cartridge 170 produces large amounts of combustion gases sufficient to rupture the container 172 of the gas generator cartridge 170. Upon rupturing of the container 172, the tank 102 is pressurized. The pressure is sufficient to rupture the disk 106 or open a poppet valve on the tank 102 leading to the nozzle 108. The pressure expels the fire suppressant through the nozzle 108 or distribution lines. A representative solid propellant 184 includes a compacted mixture of a nitrogen-containing solid fuel, such as 5-aminotetrazole, a solid oxidizer, such as strontium nitrate, and a solid coolant, such as magnesium carbonate.

The coolant serves to keep the temperature of the combustion gases sufficiently low to avoid an unwanted degree of vaporization or thermal decomposition of the fire suppressant in order to keep the fire suppressant 112 discharged from the fire extinguisher 100 at a relatively safe temperature for incidental contact with any nearby persons. A preferred propellant 184 can be provided from the General Dynamics Company of Redmond, Wash., under the designations FS01-00, FS01-40, PAC 3304, and PAC 3303. Representative propellants may additionally include surfactants and various adjuvants to impart other benefits. Other suitable propellants and adjuvants, and their amounts, for use in the hermetically sealed cartridge according to the present invention are listed in the U.S. Pat. Nos. 6,024,889; 5,613,562; 5,449,041; 5,423,384; and 6,217,788 and International Application Nos. PCT/US94/06622 and PCT/US00/05952.

Referring back to FIG. 3, the gas generator cartridge 170 may also contain a booster propellant 186 located in the upper section of the gas generator cartridge 170. The booster propellant 186 burns at a faster rate and at a hotter temperature and is provided to initiate the ignition of the solid, gas generating propellant 184. A representative booster propellant 186 is known under the designation FS01-00. The gas generator cartridge 170 may contain a screen 176 or perforated cup that separates the booster propellant 186 from the solid, gas generating propellant 184.

A perforated tube 174 is located within the interior of the container 172 of the gas generator cartridge 170. The perforated tube 174 has an exterior diameter smaller than the interior diameter of the container 172. The interior diameter of the perforated tube is sized to accommodate the required amount of solid propellant 184, while providing sufficient clearance between the exterior walls of the perforated tube 174 and the interior wall of the container 172 to dissipate the combustion gases. The perforated tube 174 has perforations 194 along the tube length. The perforated tube 174 extends along the longitudinal axis of the gas generator cartridge 170 from the lid 180 to the bottom of the container 172. The perforations 194 of the tube 174 are sized to prevent the solid propellant 184 or booster propellant 186 from passing into the space between the tube exterior and the container 172. A permeable stiffening material 196 is provided to fill the space between tube 174 and container wall 172. The permeable stiffening material 196 provides strength to the cartridge walls against the external pressure caused by the fire suppressant.

Further representative compounds useful in solid and booster propellants for the cartridge of the invention include sodium azide, copper oxide, guanidine compounds, azide compounds, azole compounds, 5-aminotetrazole or potassium, zinc, or other salts thereof, strontium nitrate, clay, guanidine nitrate, carbon, potassium perchlorate, potassium chlorate, iron oxide, bitetrazole or potassium, zinc or other salts thereof, diazoaminotetrazole or potassium, zinc, or other salts thereof, diazotetrazole dimer and its salts, aminoguanidine nitrates, nitroguanidine, triazoles (e.g., 5-nitro-1,2,4-triazole-3-one), triaminoguanidinium and diaminoguanidinium salts, and combinations thereof, alkali metal nitrates (e.g., sodium nitrate), alkaline earth nitrates (e.g., strontium nitrate), phase-stabilized ammonium nitrates, perchlorates, iodates, and bromates, glycidyl azide polymer, guanylaminotetrazole nitrate, bis(triaminoguanidium)-5,5′-azotetrazole, ammonium 5-nitroaminotetrazole, potassium iodate, potassium nitrate, potassium bromate, sodium nitrate, lithium perchlorate, alkali bromides, such as potassium bromide, alkali borates, such as potassium borate, alkali sulfates such as potassium sulfate, magnesium carbonate, and magnesium hydroxide.

In one embodiment of the gas generator cartridge 170 according to the present invention, foam pads 178 can line the bottom 181 and lid 180 of the container 172 of the gas generator cartridge 170 at locations where the solid propellant 184 and/or booster propellant 186 may come in contact with the hard interior surfaces of the gas generator cartridge 170, such as the metal container 172. The foam pads 178 can be positioned to pack the solid propellant 184 snuggly within the container and to protect and/or minimize the solid propellant 184 and/or booster propellant 186 movement and breaking apart or crumbling from hitting against the perforated tube 174, the lid 180, and bottom 181 of the container 172, such as can occur during handling of the fire extinguisher 100, or when the fire extinguisher 100 is mounted to a moving vehicle. Foam pad material can also serve to “push” the booster propellant against the gas generator cartridge lid 180 in order to position the booster propellant as close to the initiator as possible. Foam pad material is compatible with the selected solid propellant and booster propellant.

The solid propellant 184 and/or booster propellant 186, if provided, are ignited by an initiator assembly 104 (shown in FIG. 1). A suitable initiator assembly 104 is described in the International Application No. PCT/IUS00/05953. The initiator causes sufficient heat, and/or a shock wave to rupture the lid 180 on the gas generator cartridge 170, which further causes ignition of the propellant 184 within the gas generator cartridge 170.

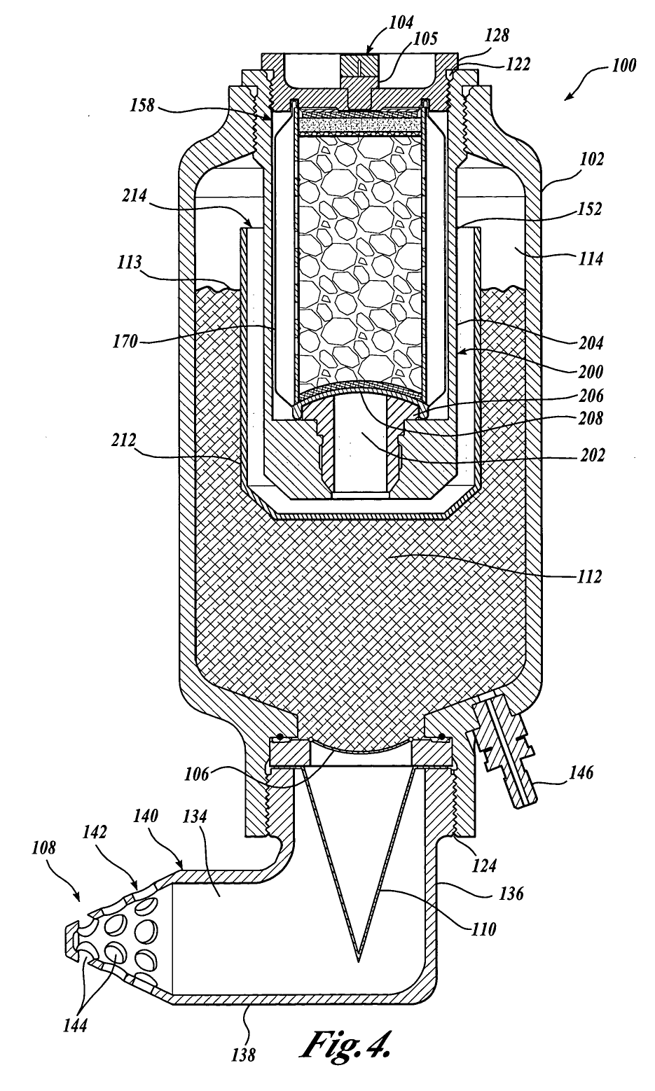

Referring now to FIG. 4, an alternate configuration of a gas generator breech 200 is illustrated. Gas generator breech 200 has no holes in the cylindrical section 204 of breech 200. Rather, breech 200 is provided with a double-walled construction in the lower section of the breech 200. The double-wall arrangement provides a gap between interior 204 and exterior 212 breech walls along the bottom and partly up the sides of the gas generator breech 200. A hole 202 in gas generator breech 200 is provided to be vertically aligned with the central axis of the cartridge 170. Hole 202 directly leads into the gap between the interior 204 and exterior 212 breech walls. Hole 202 is formed from a lower section of the breech base 206. Hole 202 connects the breech interior to the bottom gap. Breech base 206 provides buttressing support for the gas generator cartridge bottom 208 except for the space created by hole 202. The bottom exterior cartridge wall 208 adjacent to hole 202 is therefore an area of the cartridge 170 that is not buttressed against a rigid breech section, so that the bottom wall 208 is rupturable, and frangible when exposed to the increased pressures caused by ignition of the propellant within cartridge 170. Combustion gases thus rupture the cartridge bottom wall 208 at the area next to the hole 202. The gases escape through hole 202, travel radially in bottom gap, then move annularly between interior 204 and exterior 212 walls, and finally exit at location 214. It is to be appreciated that there are no release poppets or rupture discs placed in the path of the escaping gases of the gas generator breech; thus, the cartridge exterior bottom wall 208 is directly exposed to the interior environment of the fire extinguisher tank, the cartridge bottom wall 208 acting as the rupture disc. The gaps between interior and exterior cartridge walls and at the bottom, and the hole in the breech base provide a passage for combustion gases generated by the gas generator cartridge to reach the tank interior.

In different embodiments of the fire extinguisher, there may be a mechanism for manual actuation of the fire extinguisher. Furthermore, there may be a control system for actuating the fire extinguisher in response to, for example, input from a fire sensor, or input from a manually actuatable switch providing manual actuation of the fire extinguisher. The initiator assembly of the fire extinguisher may be electrically coupled to a power source, including a vehicle power source, one or more auxiliary power sources, or preferably, both for redundancy. The control system for functioning of the initiator may be microprocessor-based and may include one or more fire detection sensors (e.g., infrared sensors, thermocouples, or video sensors). Upon detection of a fire condition, the control system triggers the initiator assembly to function the fire extinguisher. The control system also may receive additional input from a person, such as via a switch, to trigger the initiator assembly and functioning of the fire extinguisher.

The hermetically sealed gas generator cartridge made in accordance with the present invention may be installed in a variety of hybrid fire extinguishers, or it can be used as a solid propellant fire extinguisher when suitable modifications and/or additions are made to the cartridge to function as a solid propellant fire extinguisher. Such modifications, for example, may include more rigid walls and a nozzle to direct the fire suppressant combustion gases to the desired coverage area. A fire extinguisher having a hermetically sealed, gas generator cartridge made in accordance with the present invention has various applications.

The fire extinguisher made in accordance with the invention, is mountable within a confined space such as an aircraft engine nacelle bay, an armored vehicle crew compartment, engine bay, automotive mechanical spaces, ammunition storage compartment, and the like. The fire extinguisher is capable of functioning in any orientation.

Another aspect of the present invention is related to a method for refurbishing the fire extinguisher. The gas generator cover with the spent initiator assembly is unscrewed and saved for re-use and the initiator is discarded. The spent gas generator cartridge is removed and discarded. A new hermetically sealed gas generator cartridge is inserted into the gas generator breech. The gas generator cover with a replacement initiator assembly is screwed into place. In addition, the fire extinguisher nozzle is unscrewed, and the tank burst disk or poppet valve is replaced or refurbished. When a poppet valve is used, it may be unnecessary to remove the nozzle. However, the nozzle can still be removed to inspect and guarantee the functioning of the release poppet. A refill amount of fluid fire suppressant is then delivered through the vent and fill valve into the tank. Refurbishing a fire extinguisher containing a hermetically sealed, gas generator cartridge thus avoids having to smooth down the gas generator breech sleeve interior of remnant burst shim(s), and the brazing of new burst shim(s) to the sleeve hole(s).

While the preferred embodiment of the invention has been illustrated and described, it will be appreciated that various changes can be made therein without departing from the spirit and scope of the invention.

1. A fire extinguisher, comprising:
(a) a tank; and
(b) a gas generator breech connected to said tank, wherein a hermetically sealed gas generator cartridge is provided within said gas generator breech.

2. The fire extinguisher of claim 1, wherein said tank comprises a fire suppressant.

3. The fire extinguisher of claim 2, wherein the fire suppressant comprises at least one of a perfluorocarbon or hydrofluorocarbon fire suppressant.

4. The fire extinguisher of claim 2, wherein the fire suppressant comprises 1,1,1,2,3,3,3-heptafluoropropane.

5. The fire extinguisher of claim 2, wherein the fire suppressant comprises a water-based fire suppressant.

6. The fire extinguisher of claim 2, wherein the fire suppressant comprises water, potassium acetate, and a surfactant.

7. The fire extinguisher of claim 1, wherein the gas generator cartridge comprises a propellant comprising a nitrogen-containing fuel, an oxidizer, and a coolant.

8. The fire extinguisher of claim 1, wherein the gas generator cartridge comprises a propellant comprising 5-aminotetrazole, strontium nitrate, and magnesium carbonate.

9. The fire extinguisher of claim 1, wherein said gas generator cartridge comprises an aluminum container.

10. The fire extinguisher of claim 1, wherein said gas generator cartridge comprises a steel container.

11. The fire extinguisher of claim 1, wherein said gas generator cartridge comprises a precursor of a beverage or food can.

12. The fire extinguisher of claim 1, wherein said gas generator cartridge comprises a precursor of a soda pop can.

13. The fire extinguisher of claim 1, wherein said gas generator cartridge comprises a lid, wherein said lid comprises an area of localized weakness.

14. The fire extinguisher of claim 1, wherein said gas generator cartridge comprises a lid, wherein said lid does not have an area of localized weakness.

15. The fire extinguisher of claim 14, further comprising a cover having an initiator assembly in proximity to the area of the gas generator cartridge lid.

16. The fire extinguisher of claim 1, further comprising a burst disk or release poppet at an outlet to said tank.

17. The fire extinguisher of claim 16, further comprising a nozzle or distribution system downstream of said burst disk or release poppet.

18. The fire extinguisher of claim 1, wherein the gas generator breech comprises a cylindrical sleeve and end plate, said sleeve and end plate are interior to said tank.

19. The fire extinguisher of claim 18, wherein the gas generator breech comprises hole(s) in said cylindrical sleeve or end plate to provide passage of combustion gases.

20. The fire extinguisher of claim 1, wherein the gas generator breech comprises an annular gap partly along the side of the gas generator breech, a bottom gap at the breech base, and a hole from the breech interior to the bottom gap, said gaps and hole to provide a passage for combustion gases.

21. The fire extinguisher of claim 1, wherein the gas generator cartridge has a burst pressure in the range of about 500 psig to about 4000 psig.

22. The fire extinguisher of claim 1, wherein the gas generator breech does not have a burst shim or a release poppet.

23. The fire extinguisher of claim 1, wherein the gas generator cartridge exterior is open to the tank interior.

24. The fire extinguisher of claim 1, wherein the gas generator cartridge comprises a precursor of a beverage or food can.

25. The fire extinguisher of claim 1, wherein the gas generator cartridge comprises a precursor of a soda pop can.

26-39. (Canceled)

40. A method for making a fire extinguisher, comprising installing a hermetically sealed gas generator cartridge in the gas generator breech of a fire extinguisher tank so that the gas generator cartridge exterior is open to the tank interior.

41-43. (Canceled)

44. A method for making a fire extinguisher, comprising:
(a) obtaining a precursor container of a beverage or food can having a propellant hermetically sealed therein; and
(b) installing said hermetically sealed precursor container in the gas generator breech of a fire extinguisher tank.

45. The fire extinguisher of claim 44, wherein said precursor container is of a soda pop can.

46. A fire extinguisher, comprising a tank, wherein a hermetically sealed, aluminum, gas generator cartridge is provided within said tank.

47. A fire extinguisher, comprising a tank, wherein a hermetically sealed, precursor container of a beverage or food can is provided within said tank.

48. The fire extinguisher of claim 47, wherein said precursor container is of a soda pop can.

49-51. (Canceled)

52. A fire extinguisher, comprising:
(a) a tank having a fire suppressant; and
(b) a gas generator breech connected to said tank, wherein said breech is configured to allow gas passage from the interior of the breech to the interior of the tank.

53. The fire extinguisher of claim 52, wherein said breech does not have a shim or release poppet in the path of the gas passage.

54. A fire extinguisher, comprising:
(a) a tank having a fire suppressant; and
(b) a gas generator breech connected to said tank; and
(c) a gas generator cartridge with a container configured to be burst at a predetermined pressure, wherein said breech does not have a shim or release poppet.
